(19) United States
(12) Patent Application Publication
(10) Pub. No.: US 2023/0128454 A1
(43) Pub. Date: Apr. 27, 2023

(54) ELECTROLYTE SPORTS DRINK FORMULATION FOR ENHANCING HYDRATION AND REPLENISHMENT OF NUTRIENTS

(71) Applicant: JHO INTELLECTUAL PROPERTY HOLDINGS, LLC, Weston, FL (US)

(72) Inventors: John H. Owoc, Southwest Ranches, FL (US); Liangxi Li, Plantation, FL (US)

(21) Appl. No.: 18/049,089

(22) Filed: Oct. 24, 2022

Related U.S. Application Data
(60) Provisional application No. 63/271,496, filed on Oct. 25, 2021.

(51) Int. Cl. A23L 2/68; A23L 33/00; A23L 29/00; A23L 33/16; C12G 3/05

(52) U.S. Cl. CPC A23L 2/68; A23L 33/30; A23L 29/045; A23L 29/035; A23L 33/16; C12G 3/05

(57) ABSTRACT

A formulation for providing hydration and nutritional components to a subject includes from about 1,000 mg/serving to about 7,000 mg/serving of trimethylglycine, a pharmaceutically acceptable salt thereof, or a pharmaceutically acceptable precursor thereof; from about 1 mg/serving to about 4,000 mg/serving of beta-hydroxybutyric acid or a pharmaceutically acceptable salt thereof; an electrolyte salt; optionally a purine nucleotide; and optionally a carbohydrate. The formulation may be an orally administered liquid including an aqueous carrier in an amount sufficient to provide a total volume/serving of about 2 oz. to about 32 oz.

### FIELD OF THE DISCLOSURE

The present development provides an electrolyte sports drink formulation for enhancing hydration and replenishment of nutrients, and methods of using such a drink for hydration of a mammalian subject.

### BACKGROUND

Commercially available sports drinks have been developed to provide for the loss of fluid (water) and various nutritional components during physical activity. Exercise and participating in a wide variety of sports are examples of physical activities in which nutritional components and fluids are lost. Other physical activities may include factory work, farm work, or other work in hot or intense conditions. People who live in extreme environmental conditions such as the tropics or deserts are also especially subject to loss of nutritional components and fluids. Dehydration has also been associated with decreased cognitive performance and spatial cognition. (Lindseth, 2013). Dehydration can be defined as an osmolality of plasma glucose and electrolytes in excess of 300 mmol/kg. “Impending” dehydration may be indicated by an osmolality of 295 to 300. (Thomas et al., 2008). Increased osmolality can be implicated in urinary tract infections, kidney disease, gastrointestinal disorders, circulatory and cardiovascular disorders, and diabetes. (El-Sharkawy et al., 2015).

The presence of certain nutrients such as electrolytes, particularly sodium and potassium, has a beneficial effect on hydration state. Other nutrients such as caffeine and alcohol have a deleterious effect on hydration. (Maughan et al., 2016). Large volumes of water may help with hydration, but they reduce osmolality and increase the risk of diuresis. Hydration beverages should not dramatically reduce osmolality and can achieve safe hydration through the inclusion of solutes and the reduction of overall fluid absorption rate. (Evans et al., 2017).

Therefore, hydration and replenishment of other nutritional components are critical for endurance, to facilitate recovery of an individual after physical activity, and avoid serious health problems. Various sports drinks are known to facilitate rehydration, and particularly to replenish electrolytes (sodium, calcium, potassium and magnesium). Fatigue is associated with electrolyte loss.

Existing sports drinks, however, do not meet the expectations of consumers. Often the ability of such drinks to rehydrate and replenish nutrients is lacking. Moreover, the taste, mouthfeel and the like are sometimes off putting. Accordingly, there is an unmet need for a sports drink that provides improved hydration and replenishment of nutritional components for consumers.

### SUMMARY

A formulation for providing rehydration and replenishment of nutritional components is provided. The formulation includes betaine one or more salts of beta-hydroxybutyrate, one or more electrolytes, and one or more purine nucleotide. The formulation may optionally include one or more carbohydrates and/or one or more nutraceutical metals or metal salts thereof.

Various embodiments disclosed herein relate to a formulation for providing hydration to a mammalian subject, where the formulation includes from about 1,000 mg/serving to about 7,000 mg/serving of trimethylglycine, alternatively, less than 1,000 mg, a pharmaceutically acceptable salt thereof, or a pharmaceutically acceptable precursor thereof; from about 1 mg/serving to about 10,000 mg/serving of beta-hydroxybutyric acid or a pharmaceutically acceptable salt thereof; an electrolyte salt; optionally a purine nucleotide; and optionally a carbohydrate. The formulation may also include an aqueous carrier in an amount sufficient to provide a total volume/serving of about 2 oz. to about 32 oz.

The formulation may include from about 1,000 mg/serving to about 2,000 mg/serving of trimethylglycine; and from about 500 mg/serving to about 2,000 mg/serving of beta-hydroxybutyric acid or a pharmaceutically acceptable salt thereof.

Various embodiments relate to a dosage form comprising the formulation for providing hydration to a mammalian subject, wherein the dosage form is an alcoholic beverage, a non-alcoholic beverage, a gel, a liquid concentrate, a powder, a tablet, or a capsule.

The formulation may contain anhydrous trimethylglycine, the pharmaceutically acceptable salt trimethylglycine HCl, or choline, glycine betaine aldehyde, or a mixture thereof as a pharmaceutically acceptable precursor of trimethylglycine.

In various embodiments, the formulation disclosed herein includes a pharmaceutically acceptable alkali metal salt of beta-hydroxybutyric acid, a pharmaceutically acceptable alkaline earth metal salt of beta-hydroxybutyric acid, or a mixture thereof. The formulation may include a sodium salt of beta-hydroxybutyric acid, a potassium salt of beta-hydroxybutyric acid, a magnesium salt of beta-hydroxybutyric acid, a calcium salt of beta-hydroxybutyric acid, or a mixture thereof.

In various embodiments of the formulation disclosed herein, the beta-hydroxybutyric acid, or the salt thereof, is a mixture of L-beta-hydroxybutyric acid and D-beta-hydroxybutyric acid, which may be a racemic mixture. The beta-hydroxybutyric acid, or the salt thereof, may be optically active, and may comprise from 75% to 100%, from 80% to 99.99%, from 90% to 99.99%, from 95% to 99.95%, or from 98% to 99.95% D-beta-hydroxybutyric acid, with the balance being L-beta-hydroxybutyric acid or a salt thereof.

In various embodiments disclosed herein, the formulation includes an electrolyte salt including a bicarbonate, citrate, phosphate, or chloride salt of an alkali metal; a bicarbonate, citrate, phosphate, or chloride salt of an alkaline earth metal; or a mixture thereof. The electrolyte salt may be a bicarbonate, citrate, phosphate, or chloride salt of sodium; a bicarbonate, citrate, phosphate, or chloride salt of potassium; a bicarbonate, citrate, phosphate, or chloride salt of magnesium; a bicarbonate, citrate, phosphate, or chloride salt of calcium; or a mixture thereof. The formulation may additionally include a pharmaceutically acceptable salt of a mineral selected from the group consisting of zinc, iron, chromium, calcium, magnesium, and mixtures thereof.

The formulation may further include a natural or artificial sweetener. Suitable natural sweeteners include steviol glycosides, honey, sugar alcohols, sugars in monosaccharide, disaccharide, oligosaccharide or polysaccharide form. Suitable artificial sweeteners include acesulfame potassium, aspartame, cyclamate, saccharin, sucralose, and combinations thereof.

Various embodiments disclosed herein relate to a method of providing hydration and nutritional components to a mammalian subject, by orally administering to the subject a formulation including from about 1,000 mg/serving to about 7,000 mg/serving of trimethylglycine, a pharmaceutically acceptable salt thereof, or a pharmaceutically acceptable precursor thereof; from about 1 mg/serving to about 4,000 mg/serving of beta-hydroxybutyric acid or a pharmaceutically acceptable salt thereof; an electrolyte salt; optionally a purine nucleotide; and optionally a carbohydrate.

The present disclosure relates to an oral formulation for providing hydration and nutritional components to a subject, including from about 100 mg/serving to about 10,000 mg/serving of trimethylglycine, a pharmaceutically acceptable salt thereof, or a pharmaceutically acceptable precursor thereof; from about 1 mg/serving to about 10,000 mg/serving of beta-hydroxybutyric acid or a pharmaceutically acceptable salt thereof; an electrolyte salt; and an aqueous carrier. The aqueous carrier is present in an amount sufficient to provide a serving size ranging from 2 oz. to 32 oz. The formulation includes anhydrous trimethylglycine, trimethylglycine HCl, or a pharmaceutically acceptable precursor of trimethylglycine, the precursor being choline, glycine betaine aldehyde, or a mixture thereof. The formulation may include beta-hydroxybutyric acid, a pharmaceutically acceptable alkali metal salt of beta-hydroxybutyric acid, a pharmaceutically acceptable alkaline earth metal salt of beta-hydroxybutyric acid, or a mixture thereof. The beta-hydroxybutyric acid, or the salt thereof, may contain from 90% to 99.99% D-beta-hydroxybutyric acid.

In various embodiments, the formulation may include from 1 mg/serving to 6,800 mg/serving of the electrolyte salt, wherein the electrolyte salt includes from 1 mg/serving to 1,500 mg/serving of a bicarbonate, citrate, phosphate, or chloride salt of sodium; from 1 mg/serving to 3,000 mg/serving of a bicarbonate, citrate, phosphate, or chloride salt of potassium; from 1 mg/serving to 300 mg/serving of a bicarbonate, citrate, phosphate, or chloride salt of magnesium; from 1 mg/serving to 2,000 mg/serving of a bicarbonate, citrate, phosphate, or chloride salt of calcium; or mixtures thereof. The formulation may include from 1 mg/serving to 1,700 mg/serving of the electrolyte salt, wherein the electrolyte salt includes from 150 mg/serving to 600 mg/serving of a bicarbonate, citrate, phosphate, or chloride salt of sodium; from 150 mg/serving to 400 mg/serving of a bicarbonate, citrate, phosphate, or chloride salt of potassium; from 1 mg/serving to 200 mg/serving of a bicarbonate, citrate, phosphate, or chloride salt of magnesium; from 1 mg/serving to 500 mg/serving of a bicarbonate, citrate, phosphate, or chloride salt of calcium; or mixtures thereof. The formulation may include from 1 mg/serving to 12 mg/serving of zinc.

Various embodiments disclosed herein relate to a method of providing hydration and nutritional components to a mammalian subject, by orally administering to the subject a formulation including from about 100 mg/serving to about 10,000 mg/serving of trimethylglycine, a pharmaceutically acceptable salt thereof, or a pharmaceutically acceptable precursor thereof; from about 1 mg/serving to about 10,000 mg/serving of beta-hydroxybutyric acid or a pharmaceutically acceptable salt thereof; an electrolyte salt; and an aqueous carrier.

Various embodiments disclosed herein relate to an oral formulation for providing hydration and of nutritional components, including from about 750 mg/serving to about 1,500 mg/serving of trimethylglycine, a pharmaceutically acceptable salt thereof, or a pharmaceutically acceptable precursor thereof; from about 500 mg/serving to about 1,000 mg/serving of beta-hydroxybutyric acid or a pharmaceutically acceptable salt thereof; from about 500 mg/serving to about 1,500 mg/serving of an electrolyte salt, wherein the electrolyte salt includes a combination of sodium and potassium salts in a ratio of 1:1, based on the weight of the cation; and a combination of magnesium and calcium; and an aqueous carrier. The trimethylglycine or the salt or precursor thereof and the beta-hydroxybutyric acid or the salt thereof may be present in a ratio of 1.4:1 to 1.6:1 by weight.

The electrolyte salt may include:
a. from 200 mg/serving to 400 mg/serving of sodium, where the sodium is administered as a bicarbonate, citrate, phosphate, or chloride salt;
b. from 200 mg/serving to 400 mg/serving of potassium, where the sodium is administered as a bicarbonate, citrate, phosphate, or chloride salt;
c. from 5 mg/serving to 25 mg/serving of a bicarbonate, citrate, phosphate, or chloride salt of magnesium;
d. from 5 mg/serving to 25 mg/serving of a bicarbonate, citrate, phosphate, or chloride salt of calcium; or
e. mixtures thereof.

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

The term “about,” as used herein when referring to a measurable value such as an amount of a compound, dose, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this invention belongs.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

All patents, patent applications and publications referred to herein are incorporated by reference in their entirety. In case of a conflict in terminology, the present specification is controlling.

The present development provides a formulation for rehydration and replenishment of nutrients. The formulation may include betaine anhydrous, one or more salts of beta-hydroxybutyrate, one or more electrolytes and one or more purine nucleotides. The formulation may further include one or more carbohydrates and one or more nutraceutical metals or metal salts thereof (e.g., zinc).

Betaine is a trimethyl glycine. In one embodiment, betaine may be in the form of pure betaine, betaine anhydrous, as a salt of betaine or as an ester of betaine such as described in U.S. Pat. No. 7,740,878 to Craig. In a preferred embodiment, betaine may be in its anhydrous form.

Beta-hydroxybutyrate (IUPAC name: 3-hydroxybutanoate) is a ketone. B-hydroxybutyrate is known to enhance energy levels, improve blood sugar levels, and enhance physical endurance. (See U.S. Publication No. 2020/0222353 to Thompson and U.S. Publication No. 2018/0195096 to Veech et al.) The beta-hydroxybutyrate may be in the form of a racemic mixture, its D-form, or its L-form. In one embodiment, the beta-hydroxybutyrate is in the form of a salt of beta-hydroxybutyrate, such as sodium beta-hydroxybutyrate, potassium beta-hydroxybutyrate, magnesium beta-hydroxybutyrate, and calcium beta-hydroxybutyrate. In some embodiments, the beta-hydroxybutyrate and/or its salts is in its D-form which is more easily broken down in the body. In other embodiments, the beta-hydroxybutyrate and/or its salts is in its L-form. In yet other embodiments, the beta-hydroxybutyrate and/or its salts is racemic beta-hydroxybutyrate.

The formulation may include electrolytes. In one embodiment, the electrolytes may be bicarbonates, citrates, phosphates, or chlorides of sodium, potassium, magnesium, or calcium. One or more of these electrolytes may be present in the formulation.

In one embodiment, the formulation may include one or more carbohydrates. The carbohydrates may act as sweeteners. In one embodiment, the carbohydrates are sugars in monosaccharide, disaccharide, oligosaccharide or polysaccharide form. Suitable carbohydrates include tagatose, galactose, trehalose, rhamnose, a cyclodextrin, maltodextrin, dextran, sucrose, glucose, ribulose, fructose, threose, arabinose, xylose, lyxose, allies, altrose, mannose, idose, lactose, maltose, invert sugar, palatinose or isomaltulose, erythrose, deoxyribose, gulose, idose, talose, erythrulose, xylulose, psicose, turanose, cellobiose, amylopectin, glucosamine, mannosamine, fucose, glucuronic acid, gluconic acid, glucono-lactone, abequose, galactosamine, beet oligosaccharides, isomalto-oligosaccharides, xylo-oligosaccharides (xylotriose, xylobiose and the like), gentio-oligoscaccharides (gentiobiose, gentiotriose, gentiotetraose and the like), sorbose, nigero-oligosaccharides, fructooligosaccharides, maltotetraol, maltotriol, malto-oligosaccharides, lactulose, melibiose, raffinose, rhamnose, and ribose.

In other embodiments, the formulation may be free of carbohydrate. Instead, the formulation may include other sweeteners, including natural sweeteners, such as steviol glycosides, and artificial sweeteners, such as acesulfame potassium, aspartame, cyclamate, saccharin, sucralose, and combinations thereof.

In some embodiments, the formulation may include modified and unmodified starches, such as: amylose, pregelatinized starches, cross-linked starches, cold-water swelling starches, stabilized starches, acid modified starches, corn starch, potato starch, tapioca starch, and wheat starch.

In some embodiments, the formulation may contain a purine nucleotide, which may be caffeine, aminophylline, (3-isobutyl-1-methylxanthine, paraxanthine, pentoxifylline, theobromine, theophylline, theacrine, other xanthines, including methylated xanthines, mixtures thereof, and derivatives thereof. In other embodiments, the formulation may be free of a purine nucleotide.

In one embodiment, the formulation may include one or more nutraceutical minerals, salts thereof, or derivatives thereof selected from the group consisting of zinc, iron, chromium, calcium, and magnesium.

The formulation may include one or more additives including flavoring agents, colorants, viscosity modifiers, preservatives, chelating agents, amino acid chelated minerals, antioxidants, amino acids and their salts, vitamins, essential fatty acids, enzymes, mono-glycerides, di-glycerides, tri-glyceride ester oils (e.g., vegetable oils and animal fats), emulsifiers, hydrolyzed proteins, whey protein, stabilizers, flow modifiers, enzymes, and surfactants, whether anionic, cationic or nonionic. Exemplary natural and artificial flavoring agents may be fruit flavor, cola flavor, vanilla flavor or chocolate flavor, for example. Likewise, agents like citric acid, fumaric acid, adipic acid, tartaric acid and lactic acid may be added for tartness.

In one embodiment, the formulation may be in the form of a packaged ready to drink beverage pre-mixed with a liquid such as water. In another embodiment, the formulation may be in the form of a dry mixture, liquid concentrates, dermal and transdermal applications, creams, gels, foods, food additives, and phospholipid nanovesicles including but not limited to liposomes, ethosomes, niosomes, transfersomes, and hydrogels.

In various embodiments, the formulation is provided as an oral dosage form including an aqueous carrier. The dosage form may include an aqueous alcoholic carrier, i.e., the formulation may be an alcoholic beverage. The dosage form may include a non-alcoholic aqueous carrier, i.e., the formulation may be a non-alcoholic beverage. The dosage form may include an aqueous carrier provided with a thickening agent, i.e., a starch or a vegetable gum, allowing the formulation to be provided as a gel. The formulation may be provided as a liquid concentrate, a powder, or a tablet, a capsule. The liquid concentrate, powder, or tablet may then be dispersed in an aqueous carrier to form a beverage. The form of the beverage may be in the form of typical beverage sizes, e.g., 8 ounces, 16 ounces, 32 ounces, and other appropriate volumes, or may be in a shot form and packages in conventional vessels. The shot form may have typical sizes such as 4 ounces, 3 ounces, 2 ounces, 1 ounce, and other larger and smaller sizes.

The dry mixture in one embodiment may be in the form of a powder. In another embodiment, the dry mixture may be in the form of a single dose tablet, gel cap, soft gel, packet, tow piece liquid capsule or the like that may be swallowed as a solid. The dry mixture or liquid concentrate or gel in another embodiment may be later reconstituted by addition of one or more liquids to form a beverage. Exemplary reconstitution liquids other than water and include fruit juices. The form of the beverage may be in the form of typical beverage sizes, e.g., 8 ounces, 16 ounces, 32 ounces, and other appropriate volumes, or may be in a shot form and packages in conventional vessels. The shot form may have typical sizes such as 4 ounces, 3 ounces, 2 ounces, 1 ounce, and other larger and smaller sizes.

The formulation may comprise per 16 oz of water: about 0.01 to about 10 g betaine anhydrous; about 0.1 to about 100,000 mg of one or more salts of beta-hydroxybutyrate; about 0.1 to about 10,000 mg of one or more electrolytes, as determined by weight of the cation; about 0.1 to about 1,000 mg of one or more purine nucleotides; about 0 to about 100 g of one or more carbohydrates, and about 0 to about 500 mg of a nutraceutical mineral.

In various embodiments, the formulation may be provided as an aqueous beverage having a volume per serving ranging from 2 oz. to 32 oz. Each serving may contain:

from about 100 mg to about 7,000 mg trimethyl glycine, from about 250 mg to about 6,000 mg trimethyl glycine, from about 400 mg to about 5,500 mg trimethyl glycine, from about 500 mg to about 5,000 mg trimethyl glycine, from about 800 mg to about 3,000 mg trimethyl glycine, from about 1,000 mg to about 2,000 mg, or from about 1,000 mg to about 1,500 mg trimethyl glycine;

from about 1 mg to about 10,000 mg, from about 5 mg to about 8,000 mg, from about 10 mg to about 4,000 mg, from about 50 mg to about 3,000 mg, from about 100 mg to about 2,500 mg, from about 500 mg to about 2,000 mg, or from about 750 mg to about 1,500 mg of one or more salts of beta-hydroxybutyrate; and

about 1 mg to about 6,800 mg, about 4 mg to about 5,000 mg, about 10 mg to about 4,000 mg, about 50 mg to about 1,700 mg, about 100 mg to about 1,000 mg, or about 400 mg to about 800 mg of one or more electrolytes, as determined by weight of the cation. The electrolyte salt may be a salt of sodium, potassium, calcium, or magnesium.

The electrolyte salt may include:

from 1 mg/serving to 1,500 mg/serving, from 10 mg/serving to 1,000 mg/serving, from 50 mg/serving to 500 mg/serving, or from 150 mg/serving to 300 mg/serving of a bicarbonate, citrate, phosphate, or chloride salt of sodium;

from 1 mg/serving to 3,000 mg/serving, from 10 mg/serving to 2,000 mg/serving, from 50 mg/serving to 1,500 mg/serving, from 150 mg/serving to 800 mg/serving, or from 200 mg/serving to 500 mg/serving of a bicarbonate, citrate, phosphate, or chloride salt of potassium;

from 1 mg/serving to 300 mg/serving, from 2 mg/serving to 200 mg/serving, from 3 mg/serving to 100 mg/serving, from 5 mg/serving to 50 mg/serving, or from 10 mg/serving to 25 mg/serving, of a bicarbonate, citrate, phosphate, or chloride salt of magnesium; and/or from 1 mg/serving to 2,000 mg/serving, from 2 mg/serving to 500 mg/serving, from 3 mg/serving to 300 mg/serving, from 5 mg/serving to 100 mg/serving, or from 10 mg/serving to 25 mg/serving, of a bicarbonate, citrate, phosphate, or chloride salt of calcium. In various embodiments, the electrolyte salt may comprise about 270 mg/serving sodium, about 270 mg/serving potassium, about 10 mg/serving magnesium, and about 13 mg/serving calcium.

In one embodiment, the pH of the formulation in water is about 2.5 to about 9.

In various embodiments, the formulation may be a solid, such as a powder, a capsule containing the powder, or a tablet. The powder may be a granulate produced by granulating a formulation including betaine anhydrous; beta-hydroxybutyric acid or a pharmaceutically acceptable salt thereof; an electrolyte; an optional purine nucleotide; and an optional nutraceutical mineral. The granulate is obtained by granulating the formulation with an aqueous or non-aqueous binder. Suitable binders include: Sugars and sugar derivatives, such as lactose, sucrose, glucose, sorbitol, xylitol, and mannitol; Natural binders, such as starch, pregelatinized starch, sodium alginate, and gelatin; and Synthetic or semisynthetic binders, such as polyvinyl pyrrolidone (PVP), methylcellulose, hydroxypropyl cellulose, hydroxypropyl methylcellulose (HPMC), polymethacrylates, sodium carboxy methyl cellulose, polyethylene glycol (PEG) and methylcellulose.

In various embodiments, the formulation may be a granulated powder suitable for dissolving or dispersing in an aqueous carrier. Alternatively, the formulation may be a tablet formed by compression of the granulated powder. The tablet may be taken orally, or dissolved in an aqueous carrier to produce an electrolyte-containing beverage. If the tablet is dissolved in an aqueous carrier, the electrolyte salt may be provided as a bicarbonate salt to produce a fizzy drink. Alternatively, if the tablet is dissolved in an aqueous carrier, the electrolyte salt may be provided as a citrate, phosphate, or chloride salt to produce a non-fizzy, or still, drink. In various embodiments, the granulate may be included in a capsule. The capsule may be administered orally to a patient.

A specific formulation may comprise ingredients including some or all of the following:

Water;

Glycerol;

isomaltulose;

phosphoric acid;

betaine anhydrous;

a salt of a hydroxybutyrate, which may be sodium D-beta-hydroxybutyrate, potassium D-beta-hydroxybutyrate, magnesium D-beta-hydroxybutyrate, calcium D-beta-hydroxybutyrate, or a mixture thereof;

citric acid or a salt thereof, where the salt may be sodium citrate, potassium citrate, magnesium citrate, or a mixture thereof;

zinc citrate;

calcium;

steviol glycosides; and

natural flavors.

Another specific formulation may comprise:

Water in an amount sufficient to provide a desired serving size in an amount ranging from 2 oz. to 32 oz.;

phosphoric acid in an amount sufficient to adjust the pH of the formulation to a desired value between 2.5 and 9;

from 1,000 to 7,000 mg/serving betaine anhydrous;

from about 100 to about 7,000 mg/serving of sodium D-beta-hydroxybutyrate, potassium D-beta-hydroxybutyrate, magnesium D-beta-hydroxybutyrate, calcium D-beta-hydroxybutyrate, or a mixture thereof;

sodium citrate, potassium citrate, magnesium citrate, and/or calcium citrate in an amount sufficient to provide about 50 to about 1,700 mg/serving of an electrolyte salt;

zinc citrate in an amount sufficient to provide about 1 to about 12 mg/serving of zinc;

steviol glycosides as a sweetener; and optionally a natural flavor.

Another specific formulation may include a solid or liquid dosage form configured to be dissolved or dispersed in an aqueous carrier, i.e., an alcoholic beverage or a non-alcoholic beverage. The dosage form may include:

phosphoric acid in an amount sufficient to adjust the pH of the carrier to a desired value between 2.5 and 9;

from 1,000 to 7,000 mg/serving betaine anhydrous;

from about 100 to about 7,000 mg/serving of sodium D-beta-hydroxybutyrate, potassium D-beta-hydroxybutyrate, magnesium D-beta-hydroxybutyrate, calcium D-beta-hydroxybutyrate, or a mixture thereof;

sodium citrate, potassium citrate, magnesium citrate, and/or calcium citrate in an amount sufficient to provide about 50 to about 1,700 mg/serving of an electrolyte salt; and

zinc citrate in an amount sufficient to provide about 1 to about 12 mg/serving of zinc.

Without being bound to any theory, it is contemplated that the formulation of the present invention improves overall hydration, and therefore, exercise performance and endurance. Ingesting the formulation may allow subjects to hydrate faster, have more energy and endurance, and to recover faster from exercise fatigue. Although the present approach has been described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present approach.

### Example 1

A formulation according to the subject matter disclosed herein is provided below:

| Formula | mg/16 oz |
|---|---|
| Betaine Anhydrous | 1250.00 |
| Zinc | 7.50 |
| Sodium | 270.00 |
| Potassium | 270.00 |
| Magnesium | 10.00 |
| Calcium | 13.00 |
| D-beta-hydroxybutyrate | 855 |

In the above formulation, the metals may be provided as pharmaceutically acceptable salts, where the salts are administered in amounts corresponding to the desired metal concentration. For example, sodium may be provided as sodium chloride. Such a formulation may contain 680 mg sodium chloride, which corresponds to 270 mg sodium ion. Similarly, the formulation may contain 1,010 mg trisodium citrate, which corresponds to 270 mg sodium ion. Also, D-beta-hydroxybutyrate may be provided as a salt in an amount corresponding to 855 mg of a D-beta-hydroxybutyrate free base. For example, 1,035 mg sodium D-beta-hydroxybutyrate corresponds to 855 mg D-beta-hydroxybutyric acid.

The formulation of Example 1 may additionally contain a natural or artificial sweetener. Suitable natural sweeteners include monosaccharide or disaccharide sugars, and steviol glycosides. Suitable artificial sweeteners include aspartame, saccharine, sucralose, neotame, and acesulfame-K.

The formulation may be dissolved or dispersed in an aqueous carrier.

Having thus described certain embodiments of the present invention, it is to be understood that the invention defined by the appended claims is not to be limited by particular details set forth in the above description including the examples as many apparent variations thereof are possible without departing from the spirit or scope thereof as hereinafter claimed.

### REFERENCES

1. Maughan, et al., A randomized trial to assess the potential of different beverages to affect hydration status: development of a beverage hydration index. The American Journal of Clinical Nutrition, 2016. 103(3), p. 717-723.
2. van Rosendal, et al., Guidelines for Glycerol Use in Hyper hydration and Rehydration Associated with Exercise. Sports Medicine, 2010, 40(2), p. 113-139.
3. Lindseth et al., Effects of Hydration on Cognitive Function of Pilots, Military Medicine, 2013, 178(7), p. 792.
4. Thomas et al., Understanding Clinical Dehydration and Its Treatment, American Medical Directors Association, 2008, 9, p. 292-301.
5. Evans et al., Optimizing the restoration and maintenance of fluid balance after exercise-induced dehydration, J. Appl. Physiol, 2017, 122, p. 945-951.
6. El-Sharkawy et al., Acute and chronic effects of hydration status on health, Nutrition Reviews, 2015, 73(S2), p. 97-109

What is claimed is:

1. A formulation, comprising:
a. from about 1,000 mg/serving to about 7,000 mg/serving of trimethylglycine, a pharmaceutically acceptable salt thereof, or a pharmaceutically acceptable precursor thereof;
b. from about 1 mg/serving to about 4,000 mg/serving of beta-hydroxybutyric acid or a pharmaceutically acceptable salt thereof;
c. an electrolyte salt;
d. optionally a purine nucleotide; and
e. optionally a carbohydrate.

2. The formulation of claim 1, further comprising an aqueous carrier in an amount sufficient to provide a total volume/serving of about 2 oz. to about 32 oz.

3. The formulation of claim 1, comprising:
from about 1,000 mg/serving to about 2,000 mg/serving of anhydrous trimethylglycine or trimethylglycine HCl; and
from about 500 mg/serving to about 2,000 mg/serving of beta-hydroxybutyric acid or a pharmaceutically acceptable salt thereof.

4. A dosage form comprising the formulation of claim 1, wherein the dosage form is an alcoholic beverage, a non-alcoholic beverage, a gel, a liquid concentrate, a powder, a tablet, or a capsule.

5. The formulation of claim 1, wherein the formulation comprises a pharmaceutically acceptable precursor of trimethylglycine, the precursor being choline, glycine betaine aldehyde, or a mixture thereof.

6. The formulation of claim 1, wherein the formulation comprises a pharmaceutically acceptable alkali metal salt of beta-hydroxybutyric acid, a pharmaceutically acceptable alkaline earth metal salt of beta-hydroxybutyric acid, or a mixture thereof.

7. The formulation of claim 6, wherein the formulation comprises a sodium salt of beta-hydroxybutyric acid, a potassium salt of beta-hydroxybutyric acid, a magnesium salt of beta-hydroxybutyric acid, a calcium salt of beta-hydroxybutyric acid, or a mixture thereof.

8. The formulation of claim 1, wherein the beta-hydroxybutyric acid is from 90% to 99.99% D-beta-hydroxybutyric acid.

9. The formulation of claim 1, wherein the electrolyte salt is selected from the group consisting of:
a bicarbonate, citrate, phosphate, or chloride salt of an alkali metal;
a bicarbonate, citrate, phosphate, or chloride salt of an alkaline earth metal; and
a mixture thereof.

10. The formulation of claim 1, further comprising a pharmaceutically acceptable salt of a mineral selected from the group consisting of zinc, iron, chromium, calcium, magnesium, and mixtures thereof.

11. A method of providing hydration and nutritional components to a mammalian subject, said method comprising orally administering the formulation of claim 1 to the subject.

12. An oral formulation, comprising:
a. from about 100 mg/serving to about 10,000 mg/serving of trimethylglycine, a pharmaceutically acceptable salt thereof, or a pharmaceutically acceptable precursor thereof;
b. from about 1 mg/serving to about 10,000 mg/serving of beta-hydroxybutyric acid or a pharmaceutically acceptable salt thereof;
c. an electrolyte salt; and
d. an aqueous carrier.

13. The oral formulation of claim 12, wherein the formulation comprises anhydrous trimethylglycine, trimethylglycine HCl, or a pharmaceutically acceptable precursor of trimethylglycine, the precursor being selected from the group consisting of choline, glycine betaine aldehyde, and a mixture thereof.

14. The oral formulation of claim 12, wherein the formulation comprises a pharmaceutically acceptable alkali metal salt of D-beta-hydroxybutyric acid, a pharmaceutically acceptable alkaline earth metal salt of D-beta-hydroxybutyric acid, or a mixture thereof.

15. The oral formulation of claim 12, wherein the formulation comprises from 1 mg/serving to 6,800 mg/serving of the electrolyte salt, wherein the electrolyte salt comprises:
i. from 1 mg/serving to 1,500 mg/serving of a bicarbonate, citrate, phosphate, or chloride salt of sodium;
ii. from 1 mg/serving to 3,000 mg/serving of a bicarbonate, citrate, phosphate, or chloride salt of potassium;
iii. from 1 mg/serving to 300 mg/serving of a bicarbonate, citrate, phosphate, or chloride salt of magnesium;
iv. from 1 mg/serving to 2,000 mg/serving of a bicarbonate, citrate, phosphate, or chloride salt of calcium; or
v. mixtures thereof.

16. The oral formulation of claim 12, further comprising from 1 mg/serving to 12 mg/serving of zinc.

17. A method of providing hydration and nutritional components to a mammalian subject, said method comprising orally administering the formulation of claim 12 to the subject.

18. An oral formulation, comprising:
a. from about 750 mg/serving to about 1,500 mg/serving of trimethylglycine, a pharmaceutically acceptable salt thereof, or a pharmaceutically acceptable precursor thereof;
b. from about 500 mg/serving to about 1,000 mg/serving of beta-hydroxybutyric acid or a pharmaceutically acceptable salt thereof;
c. from about 500 mg/serving to about 1,500 mg/serving of an electrolyte salt, wherein the electrolyte salt comprises:
a combination of sodium and potassium salts in a ratio of 1:1, based on the weight of the cation; and
a combination of magnesium and calcium; and
d. an aqueous carrier.

19. The oral formulation of claim 18, wherein the trimethylglycine or the salt or precursor thereof and the beta-hydroxybutyric acid or the salt thereof are present in a ratio of 1.4:1 to 1.6:1 by weight.

20. The oral formulation of claim 18, wherein the electrolyte salt comprises:
i. from 200 mg/serving to 400 mg/serving of sodium, where the sodium is administered as a bicarbonate, citrate, phosphate, or chloride salt;
ii. from 200 mg/serving to 400 mg/serving of potassium, where the sodium is administered as a bicarbonate, citrate, phosphate, or chloride salt;
iii. from 5 mg/serving to 25 mg/serving of a bicarbonate, citrate, phosphate, or chloride salt of magnesium; and
iv. from 5 mg/serving to 25 mg/serving of a bicarbonate, citrate, phosphate, or chloride salt of calcium.
